(19) United States
(12) Patent Application Publication
(10) Pub. No.: US 2014/0214757 A1
(43) Pub. Date: Jul. 31, 2014

(54) METHOD AND APPARATUS FOR PROVIDING USER DEVICE-BASED MASHUP SERVICES

(71) Applicant: Electronics and Telecommunications Research Institute, Daejeon (KR)

(72) Inventors: Jae Chul KIM, Daejeon (KR); Seong Ho LEE, Daejeon (KR); Yoon-Seop CHANG, Daejeon (KR); Sung Woong SHIN, Daejeon (KR)

(21) Appl. No.: 13/935,386

(22) Filed: Jul. 3, 2013

(30) Foreign Application Priority Data
Jan. 25, 2013 (KR) 10-2013-0008873

(51) Int. Cl. G06F 17/30

(52) U.S. Cl. CPC G06F 17/3053
USPC 707/608; 707/732

(57) ABSTRACT

An apparatus for providing mashup services searches a database for a mashup service corresponding to a request for a mashup service when the request is received from a user device, generates a mashup service optimized for the user device using a service block capable of executing a workflow corresponding to the mashup service and the runtime library of the user device if, as a result of the search, a mashup service corresponding to the request is not stored in the database, and provides the generated mashup service to the user device.

### CROSS-REFERENCE TO RELATED APPLICATION

This application claims priority to and the benefit of Korean Patent Application No. 10-2013-0008873 filed in the Korean Intellectual Property Office on Jan. 25, 2013, the entire contents of which are incorporated herein by reference.

### BACKGROUND OF THE INVENTION

(a) Field of the Invention

The present invention relates to a method and apparatus for providing user device-based mashup services, and more particularly, to a method and apparatus for providing mashup services optimized for user devices which can be connected to an Internet network.

(b) Description of the Related Art

As an open-type web environment has recently spread, a web browser has been mounted on a user device, thereby being capable of providing services provided using mashup.

In order to provide high-quality services, services (e.g., services associated with GPS, microphones, cameras, remote controllers, and personal calendars of smart phones) including control of the hardware of a user device and personalized data must be provided. In this case, however, economic cost and time taken to provide services are increased because services for various types of heterogeneous user devices must be directly developed.

Accordingly, in order to maximize the efficiency of mashup services, there is a need for a method capable of dynamically providing mashup services optimized for heterogeneous user devices in relation to one service.

### SUMMARY OF THE INVENTION

The present invention has been made in an effort to provide a method and apparatus for providing user device-based mashup services having an advantage of being capable of providing mashup services optimized for user devices.

According to an exemplary embodiment of the present invention, an apparatus for providing mashup services is provided. The apparatus for providing mashup services includes a mashup service provider, a mashup service manager, and a mashup service generator. The mashup service provider receives a request for a mashup service from a user device and provides the user device with a mashup service corresponding to the request. The mashup service manager searches a database for a mashup service corresponding to information about a profile of the user device. Furthermore, the mashup service generator generates a mashup service optimized for the user device based on the profile information of the user device if, as a result of the search, a mashup service corresponding to the profile information of the user device is not present in the database and transfers the generated mashup service to the mashup service provider.

The apparatus for providing mashup services further includes a block manager and a device runtime manager. The block manager searches for a service block capable of executing a workflow selected by the user device. Furthermore, the device runtime manager searches for a runtime library of the user device based on the profile information of the user device. Here, the mashup service generator generates the mashup service using the retrieved service block and the retrieved runtime library.

The apparatus for providing mashup services further includes a service workflow manager. The service workflow manager searches for workflows which can be provided by the user device based on the profile information of the user device.

The apparatus for providing mashup services further includes a device profile manager. The device profile manager searches for the profile information of the user device and provides the retrieved profile information to the mashup service manager.

The mashup service manager stores the generated mashup service in the database in response to the profile information of the user device.

According to another exemplary embodiment of the present invention, a method of providing a mashup service to a user device in an apparatus for providing mashup services is provided. The method of providing mashup services includes receiving a request for a mashup service from a user device, if a mashup service corresponding to the request is not stored in a database, generating a mashup service optimized for the user device using a service block capable of executing a workflow corresponding to the mashup service and a runtime library of the user device, and providing the generated mashup service to the user device.

Generating the mashup service optimized for the user device includes searching for workflows corresponding to the mashup service based on information about a profile of the user device, searching for the service block capable of executing a workflow selected by the user device, and searching for the runtime library of the user device using the profile information of the user device.

The method of providing mashup services may further include storing the generated mashup service in the database in response to information about a profile of the user device.

The request includes information about the user device, and the method of providing mashup services may further include searching for information about the profile of the user device based on the information of the user device after receiving the request.

### BRIEF DESCRIPTION OF THE DRAWINGS

FIG. 1 is a schematic diagram showing an apparatus for providing user device-based mashup services in accordance with an exemplary embodiment of the present invention.

FIG. 2 is a detailed diagram showing the apparatus for providing user device-based mashup services.

FIG. 3 is a flowchart illustrating a method of providing mashup services in the service providing apparatus in accordance with an exemplary embodiment of the present invention.

FIG. 4 is a flowchart illustrating a method of a mashup service generator generating mashup services in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and to description are to be regarded as illustrative in nature and not restrictive. Like reference numerals designate like elements throughout the specification.

In the entire specification and claims, unless explicitly described to the contrary, the word “comprise” and variations such as “comprises” or “comprising” will be understood to imply the inclusion of stated elements but not the exclusion of any other elements.

A method and apparatus for providing user device-based mashup services in accordance with exemplary embodiments of the present invention are described in detail below with reference to the accompanying drawings.

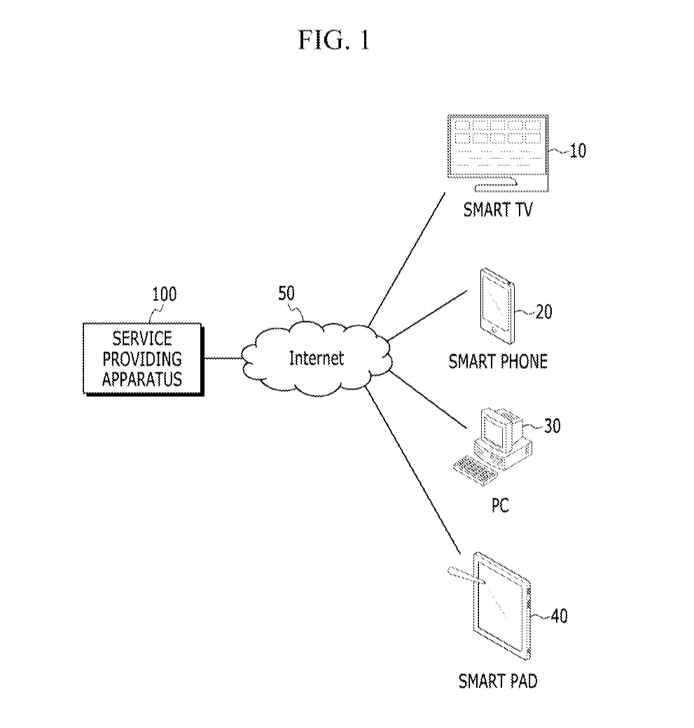

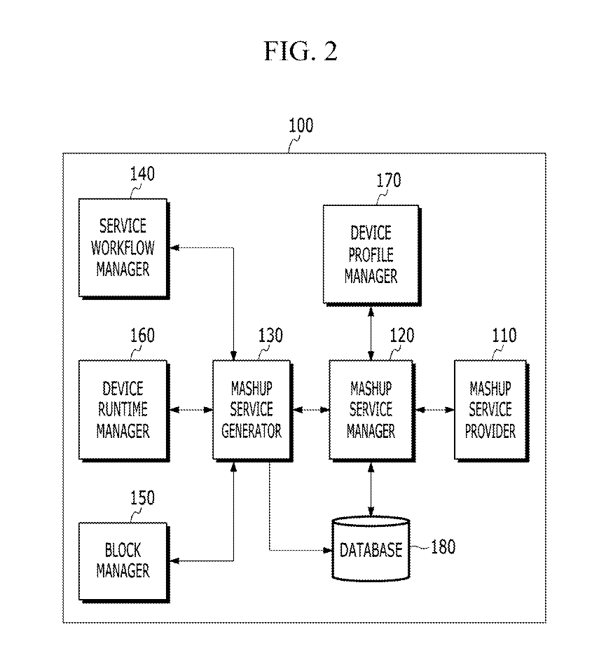

FIG. 1 is a schematic diagram showing an apparatus for providing user device-based mashup services in accordance with an exemplary embodiment of the present invention, and FIG. 2 is a detailed diagram showing the apparatus for providing user device-based mashup services.

Referring to FIG. 1, the apparatus for providing user device-based mashup services (hereinafter, “service providing apparatus”) 100 is connected to user devices 10, 20, 30, and 40 over an Internet network 50.

The service providing apparatus 100 generates mashup services optimized for the respective heterogeneous user devices 10, 20, 30, and 40 in relation to one service and provides mashup services optimized for the respective user devices 10, 20, 30, and 40 to the user devices 10, 20, 30, and 40. The mashup service can include a mashup application.

Each of the user devices 10, 20, 30, and 40 can be connected to the Internet network 50 and is a device in which a web browser is embedded. The user devices can include, for example, smart TV, a smart phone, and a smart pad.

The user devices 10, 20, 30, and 40 receive respective mashup services optimized for the service providing apparatus 100 from the service providing apparatus 100 and execute the mashup services.

Referring to FIG. 2, the service providing apparatus 100 includes a mashup service provider 110, a mashup service manager 120, a mashup service generator 130, a service workflow manager 140, a block manager 150, a device runtime manager 160, a device profile manager 170, and a database 180.

When requests for mashup services are received from the user devices 10, 20, 30, and 40, the mashup service provider 110 provides the user devices 10, 20, 30, and 40 with respective mashup services optimized for the user devices 10, 20, 30, and 40.

The mashup service provider 110 requests the mashup service manager 120 to search for a previously generated mashup service based on information about the profile of the user device 10.

The mashup service manager 120 manages mashup services stored in the database 180 and searches the database 180 for previously generated mashup services based on pieces of information about the profiles of the user devices 10, 20, 30, and 40 at the search request of the mashup service provider 110. If, as a result of the search, previously generated mashup services are stored in the database 180 in response to the pieces of profile information of the user devices 10, 20, 30, and 40, the mashup service manager 120 transfers the corresponding mashup services to the mashup service provider 110.

In contrast, if, as a result of the search, previously generated mashup services are not stored in the database 180 in response to the pieces of profile information of the user devices 10, 20, 30, and 40, the mashup service manager 120 requests the mashup service generator 130 to generate mashup services. The mashup service manager 120 stores mashup services generated by the mashup service generator 130 in the database 180 and transfers the generated mashup services to the mashup service provider 110.

The mashup service generator 130 generates the mashup services optimized for the respective user devices 10, 20, 30, and 40 by using workflows selected by the user devices 10, 20, 30, and 40, service blocks (or modules) suitable for the selected workflows, and the runtime libraries of the user devices 10, 20, 30, and 40. The mashup service generator 130 transfers the generated mashup services to the mashup service manager 120.

The service workflow manager 140 searches for workflows that can be provided by each of the user devices 10, 20, 30, and 40 at the request of the mashup service generator 130, and transfers a list of the retrieved workflows to the mashup service generator 130.

The block manager 150 searches for service blocks executable by workflows selected by the respective user devices 10, 20, 30, and 40 from the lists of workflows at the request of the mashup service generator 130, and transfers the retrieved service blocks to the mashup service generator 130.

The device runtime manager 160 manages the runtime libraries of the user devices 10, 20, 30, and 40 in response to the pieces of profile information of the user devices 10, 20, 30, and 40. The device runtime manager 160 transfers the runtime libraries of the user devices 10, 20, 30, and 40 to the mashup service generator 130 at the request of the mashup service generator 130.

The device profile manager 170 manages the pieces of profile information of the user devices 10, 20, 30, and 40. The device profile manager 170 provides information about the profile of each of the user devices 10, 20, 30, and 40. The profile information can include hardware information, software information, network information, and supported service information.

The database 180 stores mashup services.

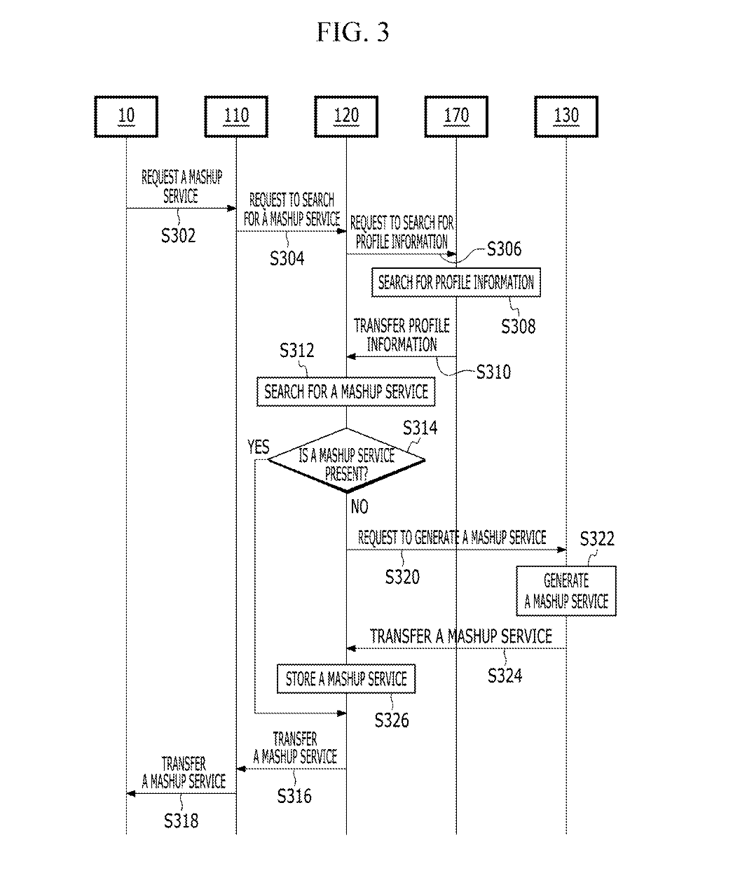

FIG. 3 is a flowchart illustrating a method of providing mashup services in the service providing apparatus in accordance with an exemplary embodiment of the present invention.

Referring to FIG. 3, the mashup service provider 110 receives a request for a mashup service from the user device (e.g., 10 of FIG. 1) at step S302. The request for the mashup service can include information about the user device 10 and information about the mashup service requested by a user.

The mashup service provider 110 requests the mashup service manager 120 to search for the mashup service at step S304.

The mashup service manager 120 requests the device profile manager 170 to search for information about the profile of the user device 10 at step S306.

The device profile manager 170 searches for information about the profile of the user device 10 at step S308, and transfers the retrieved information about the profile of the user device 10 to the mashup service manager 120 at step S310.

The mashup service manager 120 searches the database 180 for a mashup service stored in response to the profile information of the user device 10 at step S312.

If, as a result of the search, a mashup service stored in response to the profile information of the user device 10 is present in the database 180 at step is S314, the mashup service manager 120 transfers the corresponding mashup service to the mashup service provider 110 at step S316.

The mashup service provider 110 provides the user device 10 with the mashup service received from the mashup service manager 120 at step S318.

In contrast, if, as a result of the search at step S314, a mashup service stored in response to the profile information of the user device 10 is not present in the database 180, the mashup service manager 120 requests the mashup service generator 130 to generate a mashup service at step S320. The request to generate a mashup service includes the profile information of the user device 10.

In response to the request to generate a mashup service, the mashup service generator 130 generates a mashup service optimized for the profile information of the user device 10 at step S322, and transfers the generated mashup service to the mashup service manager 120 at step S324.

The mashup service manager 120 stores the mashup service generated by the mashup service generator 130 in response to the profile information of the user device 10 at step S326, and transfers the generated mashup service to the mashup service provider 110 at step S316.

The mashup service provider 110 provides the user device 10 with the mashup service received from the mashup service manager 120 at step S318.

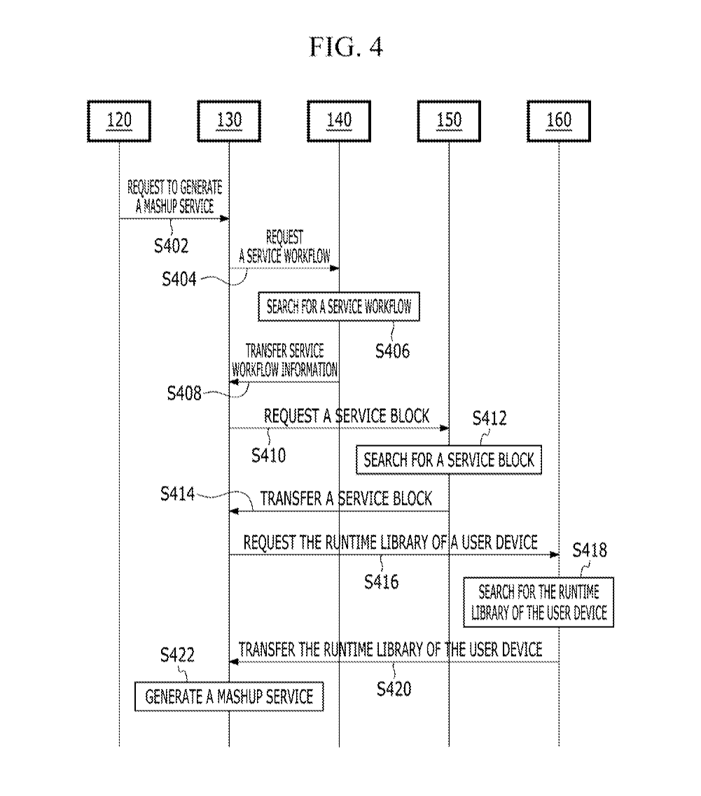

FIG. 4 is a flowchart illustrating a method of the mashup service generator generating mashup services in accordance with an exemplary embodiment of the present invention.

Referring to FIG. 4, when a request to generate a mashup service is received from the mashup service manager 120 at step S402, the mashup service generator 130 requests the service workflow manager 140 from service workflows that can be provided by the user device 10 at step S404.

The service workflow manager 140 searches for the workflows that can be provided by the user device 10 based on information about the profile of the user device 10 at step S406 and transfers information about the retrieved workflows to the mashup service generator 130 at step S408.

The mashup service generator 130 requests a service block capable of executing one workflow, selected by the user device 10 from a list of the retrieved workflows, from the block manager 150 at step S410.

The block manager 150 searches for a service block capable of executing the one workflow selected by the user device 10 at step S412 and transfers the retrieved service block to the mashup service generator 130 at step S414.

Next, the mashup service generator 130 requests the runtime library of the user device 10 from the device runtime manager 160 at step S416.

In response to the runtime library request from the mashup service generator 130, the device runtime manager 160 searches for the runtime library of the user device 10 based on the profile information of the user device 10 at step S418, and transfers the retrieved runtime library of the user device 10 to the mashup service generator 130 at step S420.

The mashup service generator 130 generates a mashup service using the service block capable of executing the workflow selected by the user device 10 and the runtime library of the user device 10 at step S422.

As described above, the mashup service generator 130 can generate a mashup service optimized for hardware personalized for each user device.

For example, if the user device 10 requests a navigation App, the mashup service manager 120 searches the database 180 in which navigation service Apps are stored for an App capable of operating in the user device 10 based on information about the profile of the user device 10.

If, as a result of the search, an App capable of operating in the user device 10 is not retrieved from the database 180, the mashup service manager 120 requests the mashup service generator 130 to generate a navigation App.

The mashup service generator 130 requests the workflow of the navigation App from the service workflow manager 140, receives the requested workflow, requests a service block capable of executing the workflow of the navigation App from the block manager 150, and receives the requested service block. A “GPS interoperation” block from among service blocks forming a navigation App may have a GPS block for each user device (e.g., a GPS block for iPhone 4S, a GPS block for iPhone 5, a GPS block for Galaxy S3, and a GPS block for Galaxy Note). The block manager 150 selects one of the service blocks based on the profile information of the user device 10 and transfers the selected service block to the mashup service generator 130. For example, if the user device 10 is a Galaxy Note (Model No: SHEV250K) based on the profile information of the user device 10, the block manager 150 searches for a GPS block for the Galaxy Note and transfers the retrieved GPS block to the mashup service generator 130. Furthermore, a block for storing navigation data can include a data storage block for iOS that can be stored only in embedded memory and a data storage block for Android capable that can be stored in external memory. The block manager 150 selects one of the data storage blocks based on the profile information of the user device 10 and transfers the selected data storage block to the mashup service generator 130.

Next, the mashup service generator 130 requests a device runtime for directly associating the navigation App with hardware from the device runtime manager 160 and receives the requested device runtime.

The mashup service generator 130 generates a navigation App optimized for the user device 10 using the received service workflow, service block, and device runtime, and provides the generated navigation App to the user device 10.

In accordance with an exemplary embodiment of the present invention, economic cost and time problems accompanied by the direct development of services for respective user devices can be solved because mashup services optimized for respective user devices are provided in relation to one service provided by a service provider. Furthermore, the limit of a service in which only an existing simple open-type service is mashed up and provided can be overcome, and thus the efficiency of mashup service providing can be maximized.

The exemplary embodiments of the present invention are not implemented only through the method and/or the apparatus, but may be implemented through a program for realizing a function corresponding to a construction according to an exemplary embodiment of the present invention or a recording medium on which the program is recorded. The implementation will be evident to a person having ordinary skill in the art to which the present invention pertains from the embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for providing mashup services, comprising:
a mashup service provider configured to receive a request for a mashup service from a user device and provide the user device with a mashup service corresponding to the request;
a mashup service manager configured to search a database for a mashup service corresponding to information about a profile of the user device; and
a mashup service generator configured to generate a mashup service optimized for the user device based on the profile information of the user device if, as a result of the search, a mashup service corresponding to the profile information of the user device is not present in the database, and transfer the generated mashup service to the mashup service provider.

2. The apparatus of claim 1, further comprising:
a block manager configured to search for a service block capable of executing a workflow selected by the user device; and
a device runtime manager configured to search for a runtime library of the user device based on the profile information of the user device,
wherein the mashup service generator generates the mashup service using the retrieved service block and the retrieved runtime library.

3. The apparatus of claim 2, further comprising a service workflow manager configured to search for workflows which can be provided by the user device based on the profile information of the user device.

4. The apparatus of claim 1, further comprising a device profile manager configured to search for the profile information of the user device and provide the retrieved profile information to the mashup service manager.

5. The apparatus of claim 1, wherein the mashup service manager stores the generated mashup service in the database in response to the profile to information of the user device.

6. A method of providing a mashup service to a user device in an apparatus for providing mashup services, the method comprising:
receiving a request for a mashup service from a user device;
if a mashup service corresponding to the request is not stored in a database, generating a mashup service optimized for the user device using a service block capable of executing a workflow corresponding to the mashup service and a runtime library of the user device; and
providing the generated mashup service to the user device.

7. The method of claim 6, wherein generating the mashup service optimized for the user device comprises:
searching for workflows corresponding to the mashup service based on information about a profile of the user device;
searching for the service block capable of executing a workflow selected by the user device; and
searching for the runtime library of the user device using the profile information of the user device.

8. The method of claim 6, further comprising storing the generated mashup service in the database in response to information about a profile of the user device.

9. The method of claim 6, wherein
the request comprises information about the user device, and
the method further comprises searching for information about a profile of the user device based on the information of the user device after receiving the request.

10. The method of claim 6, further comprising providing a mashup service corresponding to the request directly to the user device if the mashup service corresponding to the request is stored in the database.
